(19) United States
(12) Patent Application Publication
(10) Pub. No.: US 2026/0195245 A1
(43) Pub. Date: Jul. 9, 2026

(54) ERROR LOCALIZATION AND REPAIR IN SOURCE CODES AND TEST CASES

(71) Applicant: International Business Machines Corporation, Armonk, NY (US)

(72) Inventors: Vini Kanvar, Noida (IN); Sandeep Hans, Gurugram (IN); A. Eashaan Rao, Pune (IN); Shivali Agarwal, Ghaziabad (IN); Devika Sondhi, Noida (IN)

(21) Appl. No.: 19/014,414

(22) Filed: Jan. 9, 2025

(51) Int. Cl. G06F 11/3668

(52) U.S. Cl. CPC G06F 11/3672

(57) ABSTRACT

One or more systems, devices, computer program products and/or computer-implemented methods of use provided herein relate to error localization and repair in source codes and test cases. The computer-implemented system can comprise a memory that can store computer-executable components. The computer-implemented system can further comprise a processor that can execute the computer-executable components stored in the memory, where the computer-executable components can comprise a test component that can execute a test comprising a decision path. The computer-executable components can further comprise a localization component that can determine, based on one or more outcomes of the decision path, whether an error responsible for a failed test is associated with a test case or a source code.

### BACKGROUND

The subject disclosure relates to debugging and, more specifically, to error localization and repair in source codes and test cases.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable error localization and repair in source codes and test cases are discussed.

According to an embodiment, a system is provided. The system can comprise a memory that can store computer-executable components. The system can further comprise a processor that can execute the computer-executable components stored in the memory, where the computer-executable components can comprise a test component that can execute a test comprising a decision path. The computer-executable components can further comprise a localization component that can determine, based on one or more outcomes of the decision path, whether an error responsible for a failed test is associated with a test case or a source code.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can detect and repair errors in source codes and test cases, in accordance with one or more embodiments described herein.

FIG. 2 illustrates another block diagram of an example, non-limiting system that can detect and repair errors in source codes and test cases, in accordance with one or more embodiments described herein.

FIG. 3 illustrates a flow diagram of an example, non-limiting method that can be employed to detect errors in source codes and test cases and that can employ program analysis combined with a large language model (LLM) to repair the errors, in accordance with one or more embodiments described herein.

FIG. 4 illustrates a flow diagram of an example, non-limiting method that can be employed to detect whether an error responsible for a failed test is associated with a source code or a test case, in accordance with one or more embodiments described herein.

FIG. 5 illustrates a flow diagram of an example, non-limiting method that can be employed to repair an error associated with a source code, in accordance with one or more embodiments described herein.

FIG. 6 illustrates a flow diagram of an example, non-limiting method showing a practical application of the error localization and repair algorithm described with reference to FIGS. 1 and 2, in accordance with one or more embodiments described herein.

FIG. 7 illustrates a flow diagram of an example, non-limiting method that can be employed to repair errors in test cases, in accordance with one or more embodiments described herein.

FIG. 8 illustrates example, non-limiting flow diagrams of code fixes that can be employed to repair errors associated with a test case, in accordance with one or more embodiments described herein.

FIG. 9 illustrates a flow diagram of an example, non-limiting method that can be employed to repair compilation errors in a test case by employing program analysis, in accordance with one or more embodiments described herein.

FIG. 10 illustrates a flow diagram of an example, non-limiting method that can be employed to repair compilation errors in a test case by employing program analysis and an LLM, in accordance with one or more embodiments described herein.

FIG. 11 illustrates a flow diagram of an example, non-limiting method that can be employed to detect errors in source codes and test cases, in accordance with one or more embodiments described herein.

FIG. 12 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of one or more embodiments. It is evident, however, in various cases, that one or more embodiments can be practiced without these specific details.

According to an embodiment, a system is provided. The system can comprise a memory that can store computer-executable components. The system can further comprise a processor that can execute the computer-executable components stored in the memory, where the computer-executable components can comprise a test component that can execute a test comprising a decision path. The computer-executable components can further comprise a localization component that can determine, based on one or more outcomes of the decision path, whether an error responsible for a failed test is associated with a test case or a source code.

Such embodiments of the system can provide the advantage of enabling automatic and accurate localization of an error (e.g., an erroneous code or a bug).

In one or more embodiments of the aforementioned system, determining whether the error is associated with the test case, or the source code can comprise determining, by the localization component, whether the test case can compile with the source code.

Such embodiments of the system can provide the advantage of detecting compilation errors in the test case.

In one or more embodiments of the aforementioned system, the determining whether the error is associated with the test case, or the source code can further comprise determining, by the localization component, whether the test case can pass a test assertion.

Such embodiments of the system can provide the advantage of detecting assertion errors in the test case.

In one or more embodiments of the aforementioned system, the determining whether the error is associated with the test case, or the source code can further comprise determining, by the localization component, an intent associated with a code update associated with the source code. The determining whether the error is associated with the test case, or the source code can further comprise determining, by the localization component, based on the intent, whether a behavioral change associated with the source code results from the code update or the error.

Such embodiments of the system can provide the advantage of differentiating between intentional code updates and errors.

In one or more embodiments of the aforementioned system, a repair component can repair the error, where repairing the error can comprise identifying, by a code identification component, via a diff-patch analysis, an updated code associated with the error. Repairing the error can further comprise identifying, by the code identification component, via the diff-patch analysis, dependent components relevant to the updated code.

Such embodiments of the system can provide the advantage of accurately identifying the location of an error within a source code or a test case.

In one or more embodiments of the aforementioned system, the repairing of the error can further comprise identifying, by a variable identification component, one or more types of variables comprised in the updated code. Repairing the error can further comprise selecting, by the variable identification component, based on the one or more types of variables, program analysis techniques relevant to the updated code.

Such embodiments of the system can provide the advantage of identifying the most suitable techniques employable to repair the error based on the variables associated with the error.

In one or more embodiments of the aforementioned system, the repairing the error can further comprise constructing, by a graph construction component, a dependency graph based on the program analysis techniques, where respective program analysis techniques can be modeled as respective nodes of the dependency graph, and where dependencies between respective outputs of the respective program analysis techniques can be modeled as edges of the dependency graph.

Such embodiments of the system can provide advantage of defining an order of execution of the program analysis techniques given the interdependencies of the program analysis techniques.

In one or more embodiments of the aforementioned system, the repairing the error can further comprise performing, by a program analysis component, program analysis by employing the dependency graph, where the program analysis can be performed on the test case, based on a determination that the error is associated with the test case or on a combination of the source code and an original source code, based on a determination that the error is associated with the source code.

Such embodiments of the system can provide the advantage of generating accurate solutions to repair the error given the location and composition of the error.

In one or more embodiments of the aforementioned system, the repairing of the error can further comprise generating, by a prompt generation component, a dynamic prompt comprising data derived from the program analysis. Repairing the error can further comprise inputting, by the prompt generation component, the dynamic prompt to a large language model (LLM), where the LLM can generate, based on the dynamic prompt, one or more code fixes employable to repair the error.

Such embodiments of the system can provide a number of advantages, including employing prompt engineering to narrow the information processed by the LLM and employing machine learning to quickly and efficiently generate code fixes employable to repair the error.

In one or more embodiments of the aforementioned system, the repairing of the error can further comprise applying, by the repair component, one or more code fixes to the error.

Such embodiments of the system can provide the advantage of automatically, efficiently, and accurately locating and repairing errors in source codes and test cases.

An embodiment in which the program analysis component employs the dependency graph to perform program analysis and in which the prompt generation component inputs data from the program analysis into the LLM via a dynamic prompt has the advantage of improving the accuracy of code fixes generated to repair the error.

The various embodiments disclosed herein can be employed in different use cases. For example, the aforementioned system can be employed to develop and test different software. During software development, source code is often refactored (e.g., updated), which can increase the probability of errors being introduced in the source code. Once a software has been developed, the aforementioned system can be employed at the software testing stage, prior to deploying software, to repair errors in the software and to ensure that the software functions as intended.

According to various embodiments, the above-described system can be implemented as a computer-implemented method or as a computer program product.

In software development, code updates involve refactoring source codes and adding or modifying logic associated with the source codes. Refactoring can reorganize source code without changing external behavior of the source code, and adding or modifying logic can alter how an application based on the source code behaves. However, updating source code by refactoring or adding new logic can involve several challenges. For example, updating source code can introduce errors (e.g., erroneous codes or bugs), and present challenges in terms of test case maintenance and complexity management. For example, source code changes, especially ones directed to altering the behavior of source code, can introduce new errors in the source code that can affect functionality and stability of corresponding software. Existing test cases can also become obsolete or inaccurate following a code update, thereby requiring revisions to test cases to reflect new or changed behaviors of the source code. Moreover, revising a test case following a code update can also introduce errors in the test case. Additionally, both refactoring and behavior-changing updates can increase complexity of a codebase, necessitating careful management to maintain readability and the maintainability of codebase. Moreover, frequent code updates can introduce errors in both source codes and test cases, wherein such errors can be difficult to localize and fix manually.

Existing code debugging techniques assume that it is already known whether a source code or a test case is to be repaired. This assumption can lead to inefficiencies in repairing errors or incorrect repairs. LLMs can offer significant potential in addressing complexities associated with code updates by leveraging capabilities of generative artificial intelligence (AI) to understand, generate and repair source code. However, relying solely on LLMs to update source codes can be cost-prohibitive due to high computational demands imposed by LLMs. In general, existing code debugging techniques as well as LLMs are time-consuming, inefficient and imprecise for large codebases. Thus, automated solutions to quickly and accurately locate errors or pinpoint errors resulting from code updates and to resolve errors are desirable.

Various embodiments of the present disclosure can be implemented to produce a solution to these problems. Embodiments described herein include systems, computer-implemented methods, and computer program products that can detect (e.g., localize) and repair errors in both source codes and test cases by employing LLMs assisted by program analysis. Software developers frequently update code and make changes to source code via refactoring, modifying logic, or other actions that can introduce errors in source codes and/or test cases relevant to source codes. Solutions to resolve such errors can be applicable to source codes, test cases or both the source codes and the test cases. However, determining whether an error has been introduced in source code or in a test case can be challenging. As previously described, existing code debugging techniques assume that it is known whether an error has been introduced in the source code or in the test case. Resolving an error based on such assumptions can introduce further issues. Additionally, employing LLMs to resolve the error can be time consuming. On the contrary, embodiments of the present disclosure can automatically detect whether an error is associated with a source code or a test case and precisely repair the error by combining program analysis with generative AI.

For example, in one or more embodiments, an error localization and repair algorithm is provided that can localize errors responsible for failed tests to source codes or test cases. For example, a code update performed on an original source code can introduce an error in the resulting updated source code or in a corresponding test case, such that testing the updated source code with the test case can result in a failed test (e.g., a test case failure). Error localization and repair algorithm can detect whether error results from the updated source code (e.g., due to unintended behavioral changes) or an invalid test case (e.g., due to compilation errors, insufficient coverage, or assertion failures). For example, the error localization and repair algorithm can systematically compile and execute test cases on the updated source code. The test cases can be executed according to a decision path comprising a plurality of decision steps, wherein each decision step can generate a ‘Yes’ or ‘No’ outcomes. Based on outcomes of a decision path, error localization and repair algorithm can localize the error to the updated source code or the test case. Once an error is localized, the decision path can return to the test execution step and the process can begin again. That is, the decision path can be automatically and iteratively executed by the error localization and repair algorithm to localize other errors comprised in the updated source code and/or the test case.

In one or more embodiments, the error localization and repair algorithm can also repair the error by combining program analysis and generative AI. For example, in one or more embodiments, the error localization and repair algorithm can compute and compare variable values between the original source code and the updated source code, read/write dependencies between code statements to study their impact on the error, and so on. More specifically, the error localization and repair algorithm can perform a diff-patch analysis to identify updated code (e.g., a modified portion of code) and dependent components relevant to the updated code. Depending on the source of the error (e.g., the updated source code or the test case), the updated code can be associated with the updated source code or the test case. Thereafter, the error localization and repair algorithm can slice the updated code to identify code statements associated with the error. The sliced code can be subjected to variable type identification, wherein error localization and repair algorithm can determine the types of variables comprised in the sliced code and determine, based on the types of variables, suitable program analysis techniques. The error localization and repair algorithm can select and employ the program analysis techniques to construct a dependency graph that can establish/define an order of execution of the program analysis techniques. Next, the error localization and repair algorithm can employ the dependency graph to perform program analysis. If the error is localized to the updated source code, the program analysis can be applied to a combination of the original source code and the updated source code, whereas if the error is localized to the test case, the program analysis can be applied to the test case. The outcomes/results of the program analysis (e.g., program analysis data) can be employed by the error localization and repair algorithm to generate a dynamic prompt. For example, the error localization and repair algorithm can generate a dynamic prompt comprising variable values derived from the program analysis. The error localization and repair algorithm can input the dynamic prompt into an LLM, and the LLM can generate one or more code fixes that can be applied to the error by the LLM or the error localization and repair algorithm to repair the error. Thus, the error localization and repair algorithm can combine program analysis with generative AI models to accurately repair the error.

Thus, the embodiments of the present disclosure provide an automated solution comprising a robust system that can effectively manage the challenges associated with updating source codes. Such a robust system can test updated source code to ensure that the updated source code functions as intended, regardless of whether the source code was updated via refactoring or changed behaviorally, resolve errors by quickly identifying and repairing the errors in the updated source code, update test cases by adjusting existing test cases to align with the new functionalities and behaviors of the updated source code and ensure that the test cases continue to validate the software effectively.

It should be appreciated that compared to dependency graphs employed by existing techniques, the dependency graph generated by the error localization and repair algorithm based on program analysis techniques can present a more effective tool for repairing errors. For example, existing dependency graphs known in the art include control flow dependency graphs, data dependency graphs, system dependency graphs, call graphs, etc. In a control flow dependency graph, the nodes represent program statements, and the edges indicate the execution paths. In a data dependency graph, the nodes are variables, and the edges indicate data flow dependencies. A system dependency graph is employed for program slicing by capturing both control and data dependencies. In a call graph, the nodes represent procedures, and the edges represent function calls.

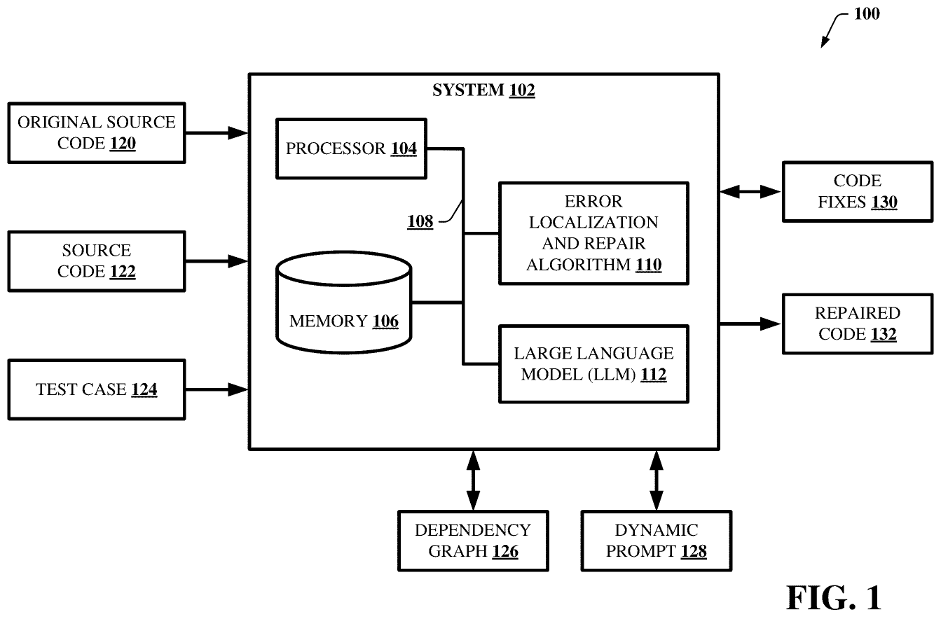

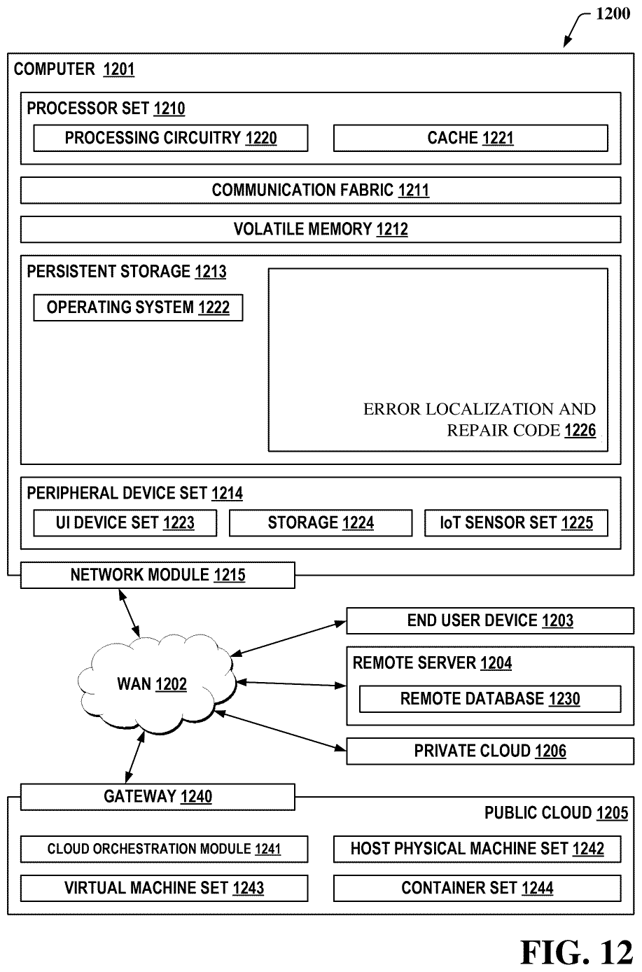

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1200 illustrated at FIG. 12. For example, non-limiting system 100 can be associated with, such as accessible via, a computing environment 1200 described below with reference to FIG. 12, such that aspects of processing can be distributed between non-limiting system 100 and the computing environment 1200. In one or more described embodiments, computer and/or computing-based elements can be used in connection with implementing one or more of the systems, devices, components, and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts. For example, acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can detect and repair errors in source codes and test cases, in accordance with one or more embodiments described herein.

Non-limiting system 100 and/or the components of non-limiting system 100 can be employed to use hardware and/or software to solve problems that are highly technical in nature (e.g., related to code debugging, program analysis, machine learning, etc.), that are not abstract and that cannot be performed as a set of mental acts by a human. Further, some of the processes performed may be performed by specialized computers for conducting defined tasks related to error localization and repair in source codes and test cases. Non-limiting system 100 and/or components of non-limiting system 100 can be employed to solve new problems that arise through advancements in technologies mentioned above, and/or the like. Non-limiting system 100 can provide technical improvements to code debugging systems by automatically, accurately and iteratively localizing and repairing errors in source codes and test cases, thereby improving the speed and efficiency of debugging source codes.

In one or more embodiments, non-limiting system 100 can comprise system 102. Discussion turns briefly to processor 104, memory 106 and bus 108 of system 102. For example, in one or more embodiments, system 102 can comprise processor 104 (e.g., computer processing unit, microprocessor, classical processor, and/or like processor). In one or more embodiments, a component associated with system 102, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, system 102 can comprise a computer-readable memory (e.g., memory 106) that can be operably connected to processor 104. Memory 106 can store computer-executable instructions that, upon execution by processor 104, can cause processor 104 and/or one or more other components of system 102 (e.g., error localization and repair algorithm 110, large language model 112 (LLM 112), compilation component 202, test component 204, localization component 206, repair component 208, code identification component 210, variable identification component 212, graph construction component 214, program analysis component 216, and prompt generation component 218) to perform one or more actions. In one or more embodiments, memory 106 can store computer-executable components (e.g., error localization and repair algorithm 110, LLM 112, compilation component 202, test component 204, localization component 206, repair component 208, code identification component 210, variable identification component 212, graph construction component 214, program analysis component 216, and prompt generation component 218). In one or more embodiments, one or more of the components of system 102 can reside in the cloud, and/or can reside locally in a local computing environment (e.g., at a specified location(s)).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network.

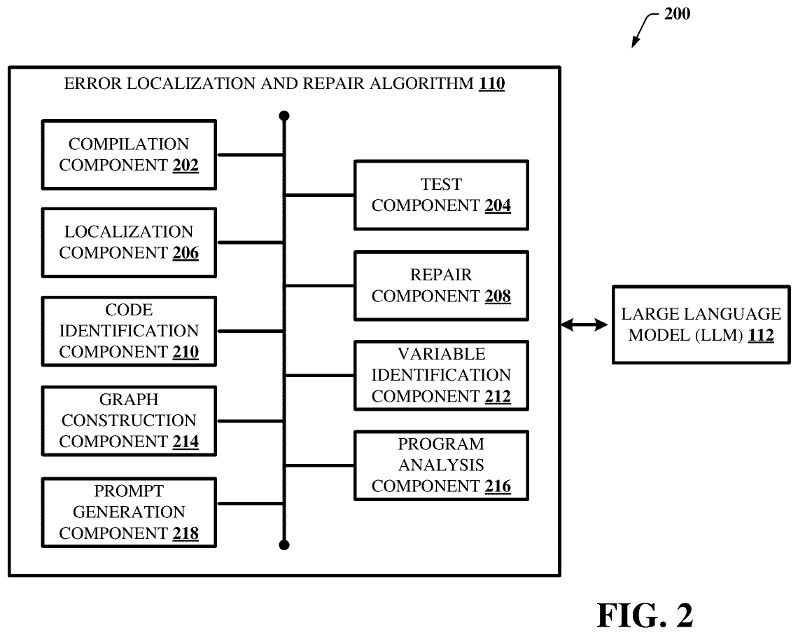

In one or more embodiments, system 102 can comprise error localization and repair algorithm 110. System 102 can additionally comprise large language model (LLM) 112. As illustrated in FIG. 2, error localization and repair algorithm 110 can further comprise compilation component 202, test component 204, localization component 206, repair component 208, code identification component 210, variable identification component 212, graph construction component 214, program analysis component 216, and prompt generation component 218. In one or more embodiments, error localization and repair algorithm 110 can be an algorithm that can localize and repair errors in both source codes and test cases. For example, in one or more embodiments, test component 204 can access inputs comprising original source code 120, source code 122 and test case 124. Based on the inputs, test component 204 can execute a test comprising a decision path. Source code 122 can be an updated version of original source code 120. For example, source code 122 can be generated by refactoring original source code 120, that is, by applying a code update to original source code 120. Test case 124 can be a test case working on/being employed on original source code 120.

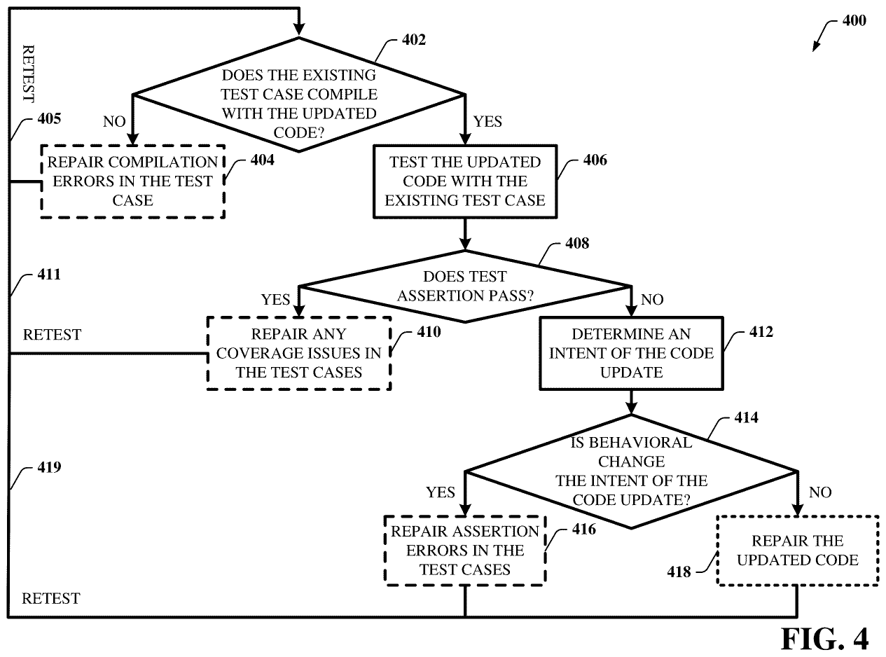

In one or more embodiments, localization component 206 can determine, based on one or more outcomes of the decision path, whether an error responsible for a failed test is associated with test case 124 or source code 122. For example, the decision path can comprise a series of decision steps, wherein each decision step can generate a ‘Yes’ or ‘No’ outcome, and wherein the outcome of each decision step can be an input to the subsequent decision step. As a result, several outcomes can be generated during execution of the decision path, and based on such outcomes, localization component 206 can determine whether source code 122 or test case 124 is to be repaired. For example, in one or more embodiments, during execution of the decision path, compilation component 202 can attempt to compile test case 124 with source code 122, and localization component 206 can determine whether test case 124 can compile with source code 122. If not, localization component 206 can determine that test case 124 comprises compilation errors that are to be repaired, and test component 204 can execute the test again. If yes, the decision path can proceed to a subsequent decision step, wherein localization component 206 can determine whether the test case can pass a test assertion. If yes, localization component 206 can determine that test case 124 comprises coverage issues that are to be repaired, and test component 204 can execute the test again. If not, the decision path can proceed to a subsequent decision step, wherein localization component 206 can determine an intent associated with a code update applied to source code 122 and further determine, based on the intent, whether a behavioral change associated with source code 122 results from the code update or the error. For example, localization component 206 can query an entity (e.g., hardware, software, machine, AI, neural network and/or user) responsible for the code update to confirm whether the intent of the code update is behavioral change. This process can assist localization component 206 in differentiating between legitimate code updates and errors and in determining whether the error stems from source code 122 or test case 124. For example, in response to a determination that the code update was intended to cause a behavioral change in source code 122, localization component 206 can infer that the error is associated with test case 124. Similarly, in response to a determination that the code update was not intended to cause a behavioral change in source code 122, localization component 206 can infer that the error is associated with the code update, and therefore, with source code 122. Accordingly, localization component 206 can determine whether source code 122 or test case 124 is to be repaired, and test component 204 can execute the test again to detect any other errors associated with source code 122 and/or test case 124. In one or more embodiments, test component 204 can iteratively and automatically execute the test to resolve errors in source code 122 and/or test case 124. The process of localizing the error based on the decision path is described in greater detail with reference to the non-limiting method 400 of FIG. 4.

In one or more embodiments, repair component 208 can employ code identification component 210, variable identification component 212, graph construction component 214, program analysis component 216, and prompt generation component 218 comprised in error localization and repair algorithm 110 to repair the error. For example, in one or more embodiments, code identification component 210 can identify, via a diff-patch analysis, an updated code associated with the error, and further identify, via the diff-patch analysis, dependent components relevant to the updated code. For example, if the error is associated with source code 122, code identification component 210 can acquire a diff-patch of changes made to original source code 120 to generate source code 122, whereas if the error is associated with test case 124, code identification component 210 can employ the diff-patch analysis to identify changes in test logic, conditions, etc. Thereafter, code identification component 210 can perform code slicing on the updated code to identify code statements corresponding to the modified lines of code in the updated code.

In one or more embodiments, variable identification component 212 can identify one or more types of variables comprised in the updated code, and based on the one or more types of variables, variable identification component 212 can select program analysis techniques relevant to the updated code. More specifically, the code slicing performed by code identification component 210 can generate a code slice (or sliced code), and variable identification component 212 can perform variable type identification on the sliced code to identify one or more types of variables comprised in the sliced code. Based on the types of variables comprised in the sliced code, variable identification component 212 can determine one or more program analysis techniques that can be employable to repair the error. For example, the sliced code can comprise integers, pointers, and/or other types of variable. If the sliced code comprises integers, variable identification component 212 can determine that a constant propagation type of program analysis technique can be applied to the sliced code. Similarly, if the sliced code comprises pointers, variable identification component 212 can determine that an alias analysis or a pointer analysis type of program analysis technique can be applied to the sliced code. In some embodiments, multiple program analysis techniques can be applied to the sliced code. For example, if the sliced code comprises both integers and pointers, variable identification component 212 can determine that both constant propagation and alias analysis can be applied to the sliced code.

In one or more embodiments, upon determination and selection of the applicable program analysis techniques by variable identification component 212, graph construction component 214 can construct, based on the program analysis techniques, dependency graph 126. For example, in one or more embodiments, graph construction component 214 can access (e.g., from a memory such as memory 106) data flow equations corresponding to the program analysis techniques and employ the data flow equations to construct dependency graph 126. Dependency graph 126 can determine/define an order in which the different program analysis techniques can be called upon/executed when performing program analysis because the program analysis techniques can be interdependent. For example, constant propagation analysis can be dependent on alias analysis such that information from alias analysis can be employed in constant propagation analysis. Such interdependencies can assist graph construction component 214 in determining an order of execution of the different program analysis techniques, and therefore, in constructing dependency graph 126.

To construct dependency graph 126, graph construction component 214 can model the respective program analysis techniques as respective nodes of dependency graph 126 and model the dependencies between respective outputs of the respective program analysis techniques as edges of dependency graph 126. That is, dependency graph 126 can model different program analysis techniques as nodes, with the edges of dependency graph 126 representing the dependencies between the respective outputs of the respective program analysis techniques. For example, respective nodes of dependency graph 126 can represent respective analysis techniques such as constant propagation, range analysis, pointer analysis, etc., and the arrows traveling from one node to another node can indicate an order of execution of the program analysis techniques. This structure of dependency graph 126 can ensure that automated systems (e.g., program analysis component 216) execute the program analysis techniques in the correct sequence.

In one or more embodiments, graph construction component 214 can combine the data flow equations corresponding to program analyses techniques that are not dependent on each other.

In one or more embodiments, program analysis component 216 can perform program analysis by employing dependency graph 126. For example, program analysis component 216 can perform program analysis by executing the program analysis techniques selected by variable identification component 212 according to the order of execution defined by dependency graph 126. Program analysis component 216 can perform the program analysis on a combination of original source code 120 and source code 122, based on a determination that the error is associated with source code 122. Similarly, program analysis component 216 can perform the program analysis on test case 124, based on a determination that the error is associated with test case 124. Stated differently, program analysis component 216 can determine whether localization component 206 has localized the error to source code 122 or test case 124, and accordingly, program analysis component 216 can perform the program analysis on a combination of original source code 120 and source code 122 or on test case 124, respectively. In one or more embodiments, program analysis component 216 can be a tool such as T.J. Watson Libraries for Analysis (WALA) by International Business Machines (IBM®) that can be employed to collect call graph information, variable values (e.g., integers, arrays, pointers, etc.).

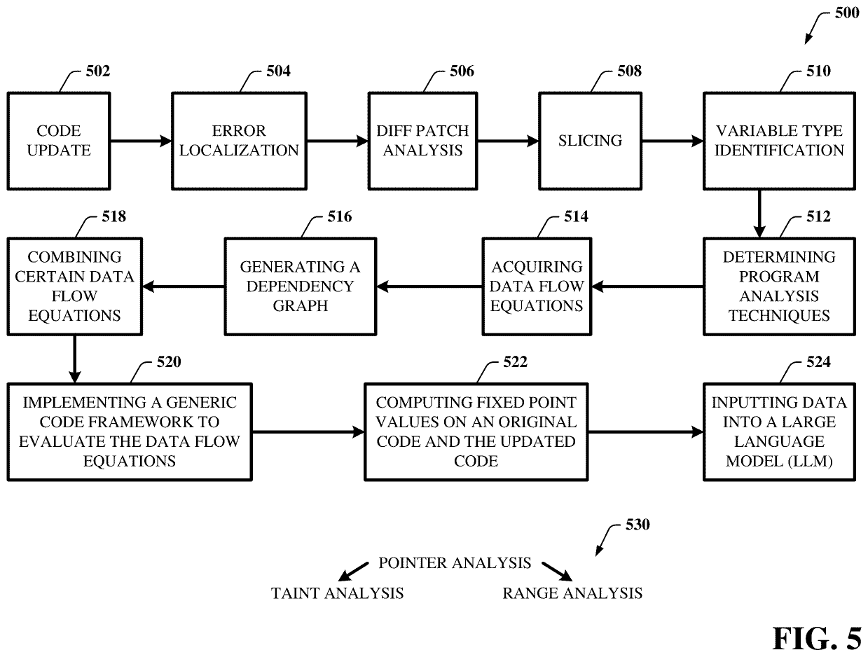

In one or more embodiments, the outputs generated during execution of the program analysis techniques by program analysis component 216 can be employed to generate a prompt that can assist LLM 112 and repair component 208 in fixing the error. For example, in one or more embodiments, prompt generation component 218 can generate dynamic prompt 128 and input dynamic prompt 128 into LLM 112. Dynamic prompt 128 can comprise data derived from the program analysis performed by program analysis component 216, and LLM 112 can generate, based on dynamic prompt 128, code fixes 130. In one or more embodiments, LLM 112 can be an LLM such as the IBM® Big AI Models (BAM), Chat Generative Pre-Trained Transformer (ChatGPT), Gemini Artificial Intelligence (Gemini AI) by Google® or another suitable LLM. Code fixes 130 can comprise one or more code fixes employable to repair the error. Accordingly, in one or more embodiments, repair component 208 or LLM 112 can apply code fixes 130 to the error and repair the error, wherein repairing the error can generate repaired code 132. The process of repairing the error is described in greater detail with reference to non-limiting method 500 of FIG. 5.

FIG. 2 illustrates another block diagram of an example, non-limiting system 200 that can detect and repair errors in source codes and test cases, in accordance with one or more embodiments described herein. Repetitive description of like elements and/or processes employed in respective embodiments is omitted for sake of brevity.

With continued reference to FIG. 1, non-limiting system 200 illustrates the system of error localization and repair algorithm 110 and LLM 112. As previously described, error localization and repair algorithm 110 can comprise compilation component 202, test component 204, localization component 206, repair component 208, code identification component 210, variable identification component 212, graph construction component 214, program analysis component 216 and prompt generation component 218. In one or more embodiments, error localization and repair algorithm 110 can employ the components illustrated by non-limiting system 200 to detect and repair errors in both source codes and test cases. In doing so, error localization and repair algorithm 110 can address at least the following challenges related to code debugging:

Identifying root causes of failed tests/test failures: Error localization and repair algorithm 110 can determine whether a test failure is caused by an error associated with a code update associated with source code 122, or whether test case 124 is to be modified (e.g., repaired).

Test suite repairs: Error localization and repair algorithm 110 can determine whether test suites such as test case 124 are to be repaired due to compilation errors, coverage errors, or assertion errors.

Pinpointing bug introductions: Error localization and repair algorithm 110 can determine how program analysis can be employed to precisely identify the portion of the code update responsible for introducing the error.

Combining LLMs with program analysis: Error localization and repair algorithm 110 can identify suitable outputs from the program analysis that can be input to LLMs for effective error correction.

Feed for LLMs: Error localization and repair algorithm 110 can identify the optimal information that can be employed to generate or craft prompts for the LLMs.

Prompt Filtering: Error localization and repair algorithm 110 can identify the types of information that can be excluded when generating the prompts for the LLMs.

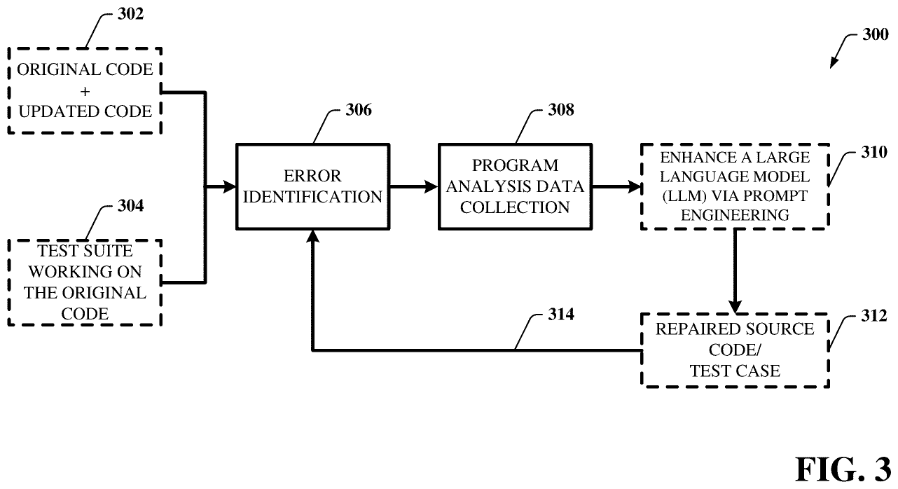

FIG. 3 illustrates a flow diagram of an example, non-limiting method 300 that can be employed to detect errors in source codes and test cases and that can employ program analysis combined with an LLM to repair the errors, in accordance with one or more embodiments described herein. Repetitive description of like elements and/or processes employed in respective embodiments is omitted for sake of brevity.

Non-limiting method 300 illustrates the process that can be employed by error localization and repair algorithm 110 (FIGS. 1 and 2) to detect whether an error stems from an invalid test case or a source code and to repair the error. For example, error localization and repair algorithm 110 can access as inputs, original source code 120 and source code 122, at 302, and test case 124 (e.g., a test suite) being executed with original source code 120, at 304. Based on the inputs, error localization and repair algorithm 110 can identify, at 306, whether an error responsible for a failed test is associated with source code 122 or test case 124. For example, test component 204 can execute a test comprising a decision path, the outcomes of which can assist localization component 206 in localizing the error. Thereafter, error localization and repair algorithm 110 can select and execute (e.g., by employing variable identification component 212, graph construction component 214 and program analysis component 216) program analysis techniques to repair the error. At 308, prompt generation component 218 can collect or access the outcomes/results of the program analysis techniques (e.g., program analysis data), and at 310, prompt generation component 218 can enhance LLM 112 via prompt engineering. For example, prompt generation component 218 can input the outcomes to LLM 112 as dynamic prompt 128. At 312, based on dynamic prompt 128, LLM 112 can generate code fixes 130 to repair the error, and LLM 112 or repair component 208 can apply code fixes 130 to the error. At 314, non-limiting method 300 can loop back to error identification at 306 to ensure that errors comprised in source code 122 and/or test case 124 are repaired one after another.

Contrary to embodiments of the present disclosure, existing code debugging techniques cannot identify whether an error is associated with a source code or a test case and do not employ an automated end-to-end program analysis framework comprising identification of program analysis techniques, dependency graph generation and prompt engineering to assist an LLM in generating refactoring suggestions (e.g., code fixes 130) that can be employed to repair the error. For example, many existing code debugging techniques employ either program analysis or machine learning, rather than a combination of program analysis and machine learning to repair errors. For example, some existing code debugging techniques employ only static or dynamic analyses without machine learning. An existing code debugging technique employs program analysis (e.g., program slicing, control flow, variable and return type usage) to check if an LLM-based refactoring was correct. Another existing code debugging technique employs static analysis (e.g., call graphs) to identify the code statements that need to change in broken test cases, and the information can be employed to fine-tune LLMs to repair broken test cases. However, this techniques assumes that the error results from the test case. Thus, embodiments of the present disclosure provide more effective and accurate methods and techniques to localize and repair errors.

FIG. 4 illustrates a flow diagram of an example, non-limiting method 400 that can be employed to detect whether an error responsible for a failed test is associated with a source code or a test case, in accordance with one or more embodiments described herein. Repetitive description of like elements and/or processes employed in respective embodiments is omitted for sake of brevity.

With continued reference to FIG. 1, non-limiting method 400 illustrates the decision path that can be assist localization component 206 in detecting whether an error is associated with a source code or a test case. As stated elsewhere herein, test component 204 can execute a test comprising the decision path, and based on one or more outcomes of the decision path, localization component 206 can determine whether an error responsible for a failed test is associated with source code 122 or test case 124. Recall that source code 122 can be an updated version of original source code 120, such that source code 122 can comprise updated code. As illustrated, each decision step in the decision path can generate a ‘Yes’ or a ‘No’ outcome based on which non-limiting method 400 can proceed to a subsequent decision step. Finally, the error can be localized to source code 122 or test case 124. For example, an outcome of ‘No’ at step 402 can indicate that test case 124 comprises a compilation error, an outcome of ‘Yes’ at step 410 can indicate that test case 124 comprises a coverage issue, an outcome of ‘Yes’ at step 416 can indicate that test case 124 comprises an assertion error, and so on. If the decision path indicates that test case 124 is not associated with any errors, localization component 206 can infer that the error is associated with source code 122, and source code 122 is to be repaired.

More specifically, at step 402, compilation component 202 can attempt to compile test case 124 with source code 122, and localization component 206 can determine whether test case 124 can compile with source code 122.

If not, then at step 404, localization component 206 can infer that test case 124 comprises compilation errors that are to be repaired. For example, localization component 206 can infer that test case 124 has failed to compile with source code 122 due to a compilation error in test case 124. At step 405, non-limiting method 400 can return to step 402 to detect any other errors associated with source code 122 and/or test case 124. That is, test component 204 can retest source code 122 with test case 124. The compilation errors in test case 124 can be introduced via refactoring. For example, during refactoring, an entity (e.g., hardware, software, machine, AI, neural network and/or user) can replace the ‘int’ function in Original source code 1 (e.g., original source code 120) with the ‘double’ function to generate Updated source code 1 (e.g., source code 122). As a result, the test statement assertEquals(3, add (1,2)) from test case 124 can generate a compilation error when test case 124 is compiled with source code 122 because the test statement can indicate that test case 124 is programmed to accept integers as inputs due to original source code 120 being based on integers (int). In one or more embodiments, repair component 208 can repair the compilation error in test case 124. For example, repair component 208 can repair the compilation errors in test case 124 by updating the test statement assertEquals(3, add (1,2)) to Test statement 1 which can generate a new test case. It should be appreciated that repairing any errors in source code 122 or test case 124 can be operations that can be performed separate from the decision path rather than being performed as part of the decision path.

Original source code 1: int add (int a, int b) { return a+b; }
Updated source code 1: double add (double a, double b) { return a+b; }
Test statement 1: assertEquals(3.0, add(1.0,2.0))

If test case 124 can compile with source code 122, then at step 406, test component 204 can test source code 122 with test case 124, and at step 408, localization component 206 can determine whether test case 124 can pass the test assertion.

For example, at step 406, source code 122 can be successfully tested with test case 124. If the test assertion passes, then at step 410, localization component 206 can infer that test case 124 comprises coverage issues that are to be repaired due to original source code 120 being updated to source code 122, and at step 411, non-limiting method 400 can return to step 402 to detect any other errors associated with source code 122 and/or test case 124. For example, Original source code 2 (e.g., original source code 120) can be programmed to compute tags based on income with a 10 percent (10%) tax rate, and Updated source code 2 (e.g., source code 122) can be programmed to add an additional surcharge applicable for income exceeding a surcharge threshold. However, if test case 124 is not updated to account for/cover source code 122 for incomes exceeding the surcharge threshold, test case 124 can still pass the test assertion. In one or more embodiments, repair component 208 can repair the coverage issues in test case 124 by adding coverage for source code 122 for income values exceeding the surcharge threshold. For example, repair component 208 can update the test statement assertEquals(500.0, calculate Tax (50.0)) from test case 124 to Test statement 2 which can generate a new test case. It should be appreciated that repairing any errors in source code 122 or test case 124 can be operations that can be performed separate from the decision path rather than being performed as part of the decision path.

```
Original source code 2:
double calculateTax(double income) {
double tax = income * 0.1; // 10% tax rate
return tax; }
Updated source code 2:
double calculateTax(double income) {
double tax = income * 0.1; // 10% tax rate
// Additional surcharge if income exceeds threshold
if (income > SURCHARGE_THRESHOLD) {
  double surcharge = income * SURCHARGE_RATE;
  tax += surcharge;}
return tax; }
Test statement 2:
// For value > SURCHARGE_THRESHOLD
assertEquals(1000.0, calculateTax(200.0))
```

If the test assertion does not pass, then at step 412, localization component 206 can determine an intent of the code update applied to original source code 120 to generate source code 122, and at step 414, localization component 206 can determine whether the intent of the code update was behavioral change. For example, in one or more embodiments, localization component 206 can prompt an entity (e.g., hardware, software, machine, AI, neural network and/or user), as needed, to confirm whether the code update associated with source code 122 is intended to introduce a behavioral change in source code 122. For example, localization component 206 can output a question to an entity (e.g., hardware, software, machine, AI, neural network and/or user) to confirm the intent of the code update. For example, localization component 206 can output a question at the user interface (UI) of a device (e.g., a desktop computer, a laptop computer, etc.), and a software developer can select (e.g., via the click of a mouse, touchscreen, etc.) a button on the UI to confirm whether the intent of the code update was behavioral change.

If the intent of the code update is behavioral change, then at step 416, localization component 206 can infer that the code update resulted in an intended behavioral change in source code 122 and test case 124 comprises assertion errors that are to be repaired. At step 419, non-limiting method 400 can return to step 402 to detect any other errors associated with source code 122 and/or test case 124. For example, Original source code 3 (e.g., original source code 120) can be programmed to convert a temperature from a value in the Celsius unit to a value in the Fahrenheit unit, and Updated source code 3 (e.g., source code 122) can be programmed to convert the temperature from a value in the Celsius unit to a value in Kelvins. That is, the code update in source code 122 is intended for a behavioral change (e.g., as confirmed by a developer or another entity (e.g., hardware, software, machine, AI, neural network and/or user). Thus, localization component 206 can infer that test case 124 comprises assertion errors that are to be repaired because a behavioral change in source code 122 can change the output of source code 122. In one or more embodiments, repair component 208 can repair assertion errors in test case 124 by updating the test statement assertEquals(41, convertCelsius(5)) to Test statement 3 which can generate a new test case. It should be appreciated that repairing any errors in source code 122 or test case 124 can be operations that can be performed separate from the decision path rather than being performed as part of the decision path.

```
Original source code 3:
double convertCelsius (double celsius) {
  return (celsius * 9 / 5) + 32; // ToFahrenheit }
Updated source code 3:
double convertCelsius (double celsius) {
  return celsius + 273.15; // ToKelvin}
Test statement 3: assertEquals(278.15, convertCelsius(5))
```

If the intent of the code update is not behavioral change, then at step 418, localization component 206 can infer that source code 122 is associated with an error (e.g., an unintended behavioral change) and source code 122 is to be repaired. At step 419, non-limiting method 400 can return to step 402 to detect any other errors associated with source code 122 and/or test case 124. For example, if the developer confirms that the intent of the code update is not behavioral change, localization component 206 can infer that source code 122 is associated with an error. For example, Original source code 4 (e.g., original source code 120) can be programmed to function as a discount calculator that can access the original price of an item as input and generate a final price after applying a 20% discount rate to the original price. The developer can update Original source code 4 to Updated source code 4 by doubling the original price followed by dividing the discount rate in half to account for the initial doubling, and the developer can conclude that the internal changes thus made to Original source code 4 should not change the outcome of Original source code 4. Accordingly, the developer can confirm that the internal changes do not constitute a behavioral change. However, due to the inability of test case 124 to pass the test assertion test, localization component 206 can infer that the updated code comprises an error introduced by the developer, for example, by dividing the discount rate instead of multiplying the discount rate. Thus, localization component 206 can further infer that source code 122 is to be repaired instead of the test statement assertEquals(discountCalculator, 80.0); in test case 124.

```
  Original source code 4:
  double discountCalculator( ) {
  double originalPrice = 100;
  double discountRate = 0.2; // 20% discount
  double discountAmount = originalPrice * discountRate;
  double finalPrice = originalPrice − discountAmount;
  return finalPrice; }
  Updated source code 4 ( Incorrect update code with an incorrect division in line
6):
  double discountCalculator( ) {
  double originalPrice = 200;
  double discountRate = 0.4;
  originalPrice = originalPrice / 2; // Changed intermediate step
  discountRate = discountRate / 2; // Changed intermediate step
  double discountAmount = originalPrice / discountRate; // Error
  double finalPrice = originalPrice − discountAmount;
  return finalPrice; }
```

Thus, the decision path can assist localization component 206 in localizing the error responsible for a failed test to source code 122 or test case 124.

FIG. 5 illustrates a flow diagram of an example, non-limiting method 500 that can be employed to repair an error associated with a source code, in accordance with one or more embodiments described herein. Repetitive description of like elements and/or processes employed in respective embodiments is omitted for sake of brevity.

With continued reference to FIGS. 1 and 4, non-limiting method 500 illustrates how error localization and repair algorithm 110 can employ LLMs assisted by a program analysis framework to repair an error associated with a source code. Although not illustrated, it should be appreciated that the non-limiting method 500 can also be employed to repair errors in test cases.

At step 502, an entity (e.g., hardware, software, machine, AI, neural network and/or user) can update original source code 120 to source code 122. For example, a developer can update Original source code 5 (e.g., original source code 120) to Updated source code 5 (e.g., source code 122), and the code updated applied to Original source code 5 can introduce an error in Updated source code 5. For example, Original source code 5 can be programmed to iterate over an array from 0 to n, sum the integers and return the sum. However, the code update can cause Updated source code 5 to iterate on values that are out of bounds for Updated source code 5.

```
Original source code 5:
func(int arr[ ], int n) {
  int *p = arr;
  int sum = 0;
  for (int i = 0; i < n; i++)
    sum += *(p + i);
  return sum; }
Updated source code 5:
func(int arr[ ], int n) {
  int *p = arr;
  int sum = 0;
  for (int i = 0; i <= n; i++) // Potential out of bounds access
    sum += *(p + i);
  return sum; }
```

At step 504, test component 204 can access original source code 120, source code 122 and test case 124 as inputs and execute a test comprising a decision path, and localization component 206 can localize the error responsible for a failed test to source code 122, as described with reference to non-limiting method 400. Test case 1 illustrates an exemplary test case corresponding to Original source code 5 and Updated source code 5.

Test case 1:
int arr[5] = {1, 2, 3, 4, 5};
assertEquals(arr, 5, 15);

At step 506, code identification component 210 can employ diff-patch analysis to identify an updated code and dependent components relevant to the updated code. For example, code identification component 210 can take a diff-patch of updates made to original source code 120 to identify that Original line of code 1 has been updated to Updated line of code 1 (e.g., by changing the sign at the beginning of the line of code, updating the mathematical operators, etc.).

Original line of code1:−for(int i=0;i<n;i++){//Original line

Update line of code1:+for(int i=0;i<=n;i++){//Updated line

At step 508, code identification component 210 can slice the updated code to identify statements affecting the modified lines of code in source code 122. That is, code identification component 210 can identify the portion of source code 122 affected by the specific code updates applied to original source code 120. Slicing the updated code can generate a sliced code, such as Sliced code 1.

Sliced code 1:
for (int i = 0; i <= n; i++)
sum += *(p + i);

At step 510, variable identification component 212 can perform variable type identification, wherein variable identification component 212 can identify the types of variables (e.g., stack pointers, heap pointers, arrays, integers, etc.) comprised in the sliced code. For example, the sliced code can comprise an array of integers (arr), a pointer to integers (p), an integer (sum), and so on.

At step 512, variable identification component 212 can perform analysis identification, wherein variable identification component 212 can determine, based on the one or more types of variables comprised in the sliced code, the program analysis techniques applicable to the sliced code. For example, variable identification component 212 can determine that since the sliced code comprises integers, range analysis, taint analysis and pointer analysis are the program analysis techniques applicable to the sliced code. In software development, range analysis can determine the range of possible values that a variable can accept during execution of source code, taint analysis can track the flow of potentially harmful data through source code, and pointer analysis can evaluate and understand the behavior of pointers in source code.

At step 514, graph construction component 214 can acquire (e.g., from a memory such as memory 106), data flow equations of relevant program analysis techniques. Equations 1, Equations 2 and Equations 3 describe the respective data flow equations corresponding to the pointer analysis, the range analysis and the taint analysis, wherein the ‘In’ command describes information entering a statement/block, the ‘Out’ command describes information exiting a statement/block, the ‘Gen’ command describes the information generated by a statement/block, and the ‘Kill’ command describes the information that is invalidated by a statement/block.

$$In ( p ) = ∅ ( for all pointers p ) \qquad Equations 1 : Pointer analysis$$

$$Out ( p ) = PointsTo ( p ) ( for all pointers p )$$

$$At Assignment p = v :$$

$$Gen ( p ) = PointsTo ( v ) , Kill ( p ) = Out ( p )$$

$$Data Flow Equation :$$

$$Out ( p ) = ( In ( p ) - Kill ( p ) ) ⋃ Gen ( p )$$

$$In ( input ) = True ( for all tainted inputs ) \qquad Equations 2 : Taint analysis$$

$$Out ( input ) = True ( for all tainted inputs )$$

$$At Assignment v = u$$

$$Gen ( v ) = Tainted ( u ) , Kill ( v ) = Tainted ( v )$$

$$At assignment p = u$$

$$Gen ( deref ( p ) ) = Tainted ( u ) ( where deref ( p ) is the value pointed by p )$$

$$Data Flow Equation : Out ( v ) = ( In ( v ) - Kill ( v ) ) ⋃ Gen ( v )$$

$$In ( v ) = [ min ( v ) , max ( v ) ] ( for each variable v ) \qquad Equations 3 : Range analysis$$

$$Out ( v ) = [ min ( v ) , max ( v ) ] ( for each variable v )$$

$$At Assignment v = u$$

$$Gen ( v ) = Range ( u ) , Kill ( v ) = Out ( v )$$

$$At statement asccessing * p [ i ]$$

$$Gen ( i ) = Range ( deref ( p ) [ i ] )$$

$$Data Flow Equation : Out ( v ) = ( In ( v ) - Kill ( v ) ) ⋃ Gen ( v )$$

As described by data flow equations for the pointer, taint and range analyses, a data flow equation is a type of recursive equation that can calculate the values of the variables at the input of a statement and at the output of the statement. That is, a data flow equation can calculate a value of a variable before executing a statement and calculate the value of the variable after executing the statement.

Data flow equations are standard equations in program analysis, and at step 516, graph construction component 214 can employ data flow equations known in the art to generate dependency graph 126. As stated elsewhere herein, dependency graph 126 can define an order of execution of the program analysis techniques applicable to the sliced code because program analysis techniques can be interdependent. For example, when computing the value of a variable, taint analysis can be dependent on pointer analysis if the variable is a pointer. For example, taint analysis can be dependent on pointer analysis according to Gen(deref(p))=Tainted(u). Similarly, range analysis can be dependent on pointer analysis according to Gen(i)=Range(deref(p)[i]). Thus, dependency graph 126 can account for the interdependencies amongst respective program analysis techniques. The dependencies between the pointer, taint, and range analyses in dependency graph 126 are illustrated at 530 in FIG. 5.

At step 518, graph construction component 214 can combine the data flow equations corresponding to program analyses techniques that are not dependent on each other. For example, since taint analysis and range analysis have no dependency on each other, their data flow equations can be combined for efficiency. The combined equations can be given by OutTaint(v)=(InTaint(v)−KillTaint(v))∪GenTaint(v) for taint analysis and OutRange(v)=(InRange(v)−KillRange(v))∪GenRange(v) for range analysis.

At step 520, program analysis component 216 can implement a generic coding framework to evaluate the data flow equations.

Program 1 presented below is a generic program that can be employed by program analysis component 216 to implement and evaluate data flow equations. Program 1 represents a generalized program that can compute data flow equations for an input program, given an existing set of data flow equations. Stated differently, Program 1 represents a high-level pseudo code showing how dependency graph 126 can be computed by graph construction component 214 and how the data flow equations can be called upon by program analysis component 216 for execution. Program 1 can be structured to accept data flow equations, variables, and initial values of variables. In Program 1, the DataFlowAnalyzer class represents the core class responsible for managing variables and data flow equations, add_variable represents a method to add variables with their initial values, add_data_flow_equation represents a method to input the data flow equations in a simple string format, compute_fixed_point represents a method that can iterate over the equations, evaluating them until no changes occur, thereby indicating that a fixed point has been reached, evaluate_equation represents a method to parse and evaluate the equations dynamically, and print variables represents a utility to display the final values of all variables after computations. Program 1 is an exemplary program that can employ the eval( ) function to compute values, assuming a proper format and safety checks.

```
Program 1:
class DataFlowAnalyzer:
  def _{——}init_{——}(self):
    self.variables = { }
    self.data_flow_eqs = [ ]
  def add_variable(self, name, initial_value):
    self.variables[name] = initial_value
  def add_data_flow_equation(self, equation):
    self.data_flow_eqs.append(equation)
  def compute_fixed_point(self):
    changes = True
    while changes:
      changes = False
      for eq in self.data_flow_eqs:
        new_values = self.evaluate_equation(eq)
        for var, value in new_values.items( ):
          if self.variables[var] != value:
            self.variables[var] = value
            changes = True
def evaluate_equation(self, equation):
    # Simple parser for evaluating equations
    # Here we assume the equation is in a simple format
    # Example: “sum = a + b” or “r = a − b” and returns a dict of new values
    lhs, rhs = equation.split(“=”)
    lhs = lhs.strip( )
    rhs = rhs.strip( )
    # Assuming rhs consists of variable names or numbers
    value = eval(rhs, { }, self. variables)
    return {lhs: value}
  def print_variables(self):
    for var, value in self.variables.items( ):
      print(f“{var} = {value}”)
# Example of using the DataFlowAnalyzer
analyzer = DataFlowAnalyzer( )
analyzer.add_variable(‘a’, 3)
analyzer.add_variable(‘b’, 5)
analyzer.add_data_flow_equation(‘sum = a + b’)
analyzer.add_data_flow_equation(‘diff = a − b’)
# Compute fixed points
analyzer.compute_fixed_point( )
# Print final variable values
analyzer.print_variables( )
```

At step 522, program analysis component 216 can employ dependency graph 126 to perform program analysis. For example, program analysis component 216 can compute fixed point values on original source code 120 and source code 122 (since the error is localized to source code 122). Since data flow equations are recursive equations, they typically involve fixed point computations. Thus, program analysis component 216 can execute the data flow equations on original source code 120 and source code 122. Table 1 illustrates the outcomes resulting from step 522 given Program 1. For example, pointer analysis can indicate that p points to arr[0] in both the original source code and the updated source code, range analysis can indicate that the index i ranges from 0 to n-1 in the original source code and from 0 to n in the updated source code, and taint analysis can indicate that the array is tainted in both the original source code and the updated source code.

TABLE 1

| Program analysis type | Original code | Update code |
|---|---|---|
| Pointer analysis | p points to arr[0] | Same |
| Range analysis | Range(i) = [0, n − 1] | Range(i) = [0, n] |
| Taint analysis | Tainted(arr) → Tainted(sum) | Same |

At step 524, prompt generation component 218 can generate dynamic prompt 128 comprising the relevant outcomes from step 522 and input dynamic prompt 128 to LLM 112. Based on dynamic prompt 128, LLM 112 can identify the code update and the corresponding error in source code 122 and accordingly, generate code fixes 130 that can be applied by repair component 208 or LLM 112 to the error to fix the error. For example, the difference between the range for index i from [0, n−1] to [0, n] and information about the localization of the error to source code 122 can be input to LLM 112 via dynamic prompt 128 based on which, LLM 112 can generate a code fix for the error.

The experimental results presented below describe how the embodiments of the present disclosure can employ LLMs to fix errors in source codes and test cases. In the experiments that were conducted, four programs with their existing test cases and source codes were employed along with an original source code, an updated source code and a working test case. The LLMs employed were IBM® BAM, ChatGPT and Gemini AI by Google®. Prompt 1 describes the prompt that was generated and input (e.g., by prompt generation component 218) to each LLM. Specifically, program analysis component 216 employed program analysis to filter out relevant program files, and subsequent to the filtering, prompt generation component 218 generated a dynamic prompt and fed the dynamic prompt to the LLM being tested. It should be noted that Prompt 1 does not comprise program analysis results. It was observed that the LLMs generated varied repair suggestions (e.g., code fixes), and despite filtering out relevant program files, only a few LLMs were able to repair the failed test cases.

Prompt 1:
<<Prompt Instructions>>
Instruction: Fix the provided test method statement based on the context given in
the enclosing test method and Java source files.
Test Method: {TEST_METHOD}
Test Statement: {TEST_STATEMENT}
Java source files relevant to test methods:
{File1.java}
{File2.java}
Please provide the fix only for “Test Statement”. No explanations needed.

Table 2 lists the results of fixed assertion statements demonstrated in the Motivating Example from the apache/commons-io repository from GitHub™ for commit 7c111fe.

TABLE 2

| Model name | Test method result |
|---|---|
| IBM ® Granite 13B | Error |
| IBM ® Granite 20B | Pass |
| IBM ® Granite 34B | Pass |
| Llama ™ 13B | Error |
| Google ® Gemini | Error |

Table 3 shows the dataset employed in the experimentation. This dataset is taken from Y. Kashiwa et al. (Y. Kashiwa et al., “Does Refactoring Break Tests and to What Extent?,” 2021 IEEE International Conference on Software Maintenance and Evolution (ICSME), Luxembourg, 2021, pp. 171-182, doi: 10.1109/ICSME52107.2021.00022.) and comprises 6 Java projects, 135 instances of test breakages and 7 refactoring types. It should be noted that the original dataset does not include information on error messages and error types.

TABLE 3
Summary of a dataset under study.

| | | History | | | | | |
|---|---|---|---|---|---|---|---|
| | | | | Test | Test cases | | |
| | | | | breakage | Broke | | |
| | | | Refactoring | refactoring | test | Test | Errors |
| Project | Domain | Commits | commits | commits | files | method | identified |
| Commons- | IO | 2,740 | 444 | 7 | 17 | 55 | 169 |
| io | Functional | | | | | | |
| | Library | | | | | | |
| Jsoup | HTML | 1,386 | 289 | 6 | 13 | 16 | 97 |
| | Library | | | | | | |
| Little | HTTP | 1,003 | 252 | 1 | 1 | 2 | 13 |
| Proxy | Proxy | | | | | | |
| Rxjava - | Database | 850 | 186 | 3 | 5 | 24 | 24 |
| JDBC | Client | | | | | | |
| | Library | | | | | | |
| Spark | Web | 1,062 | 309 | 2 | 2 | 3 | 5 |
| | Framework | | | | | | |
| Spoon | Program | 3,278 | 878 | 1 | 6 | 8 | 8 |
| | Analysis | | | | | | |
| | Library | | | | | | |

Table 4 shows the preliminary results of the experiments conducted based on the dataset shown in Table 3.

| | | | Number | | | | Solved |
|---|---|---|---|---|---|---|---|
| | | Number | of test | | | Solved | through |
| | | of test | cases/ | | | through | program |
| | Commit | files to | methods | | Unique | program | analysis + |
| Project | ID | repair | to repair | Errors | errors | analysis | LLMs |
| Commons-io | 7c111fe | 6 | 27 | 114 | 23 | 42 | 72 |
| Commons-io | 3798a6b | 2 | 12 | 16 | 1 | All | Not required |
| Commons-io | e21df7d | 2 | 4 | 6 | 1 | All | Not required |
| Jsoup | 528ba55 | 2 | 3 | 10 | 1 | All | Not required |
| Jsoup | b001b30 | 1 | 1 | 1 | 1 | All | Not required |

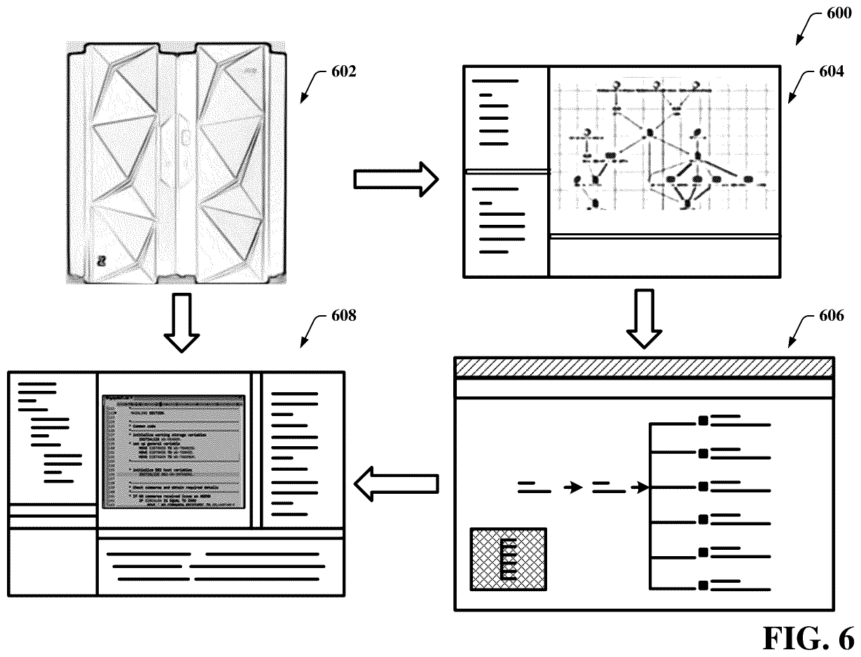

FIG. 6 illustrates a flow diagram of an example, non-limiting method 600 showing a practical application of the error localization and repair algorithm described with reference to FIGS. 1 and 2, in accordance with one or more embodiments described herein. Repetitive description of like elements and/or processes employed in respective embodiments is omitted for sake of brevity.

Non-limiting method 600 can be employed to develop new software and applications.

At step 602, an application source code can be analyzed in an analysis tool (e.g., IBM® Application Discovery and Delivery Intelligence (ADDI)).

At step 604, a service designer can be employed to focus on specific application areas and break services out of the application areas.

At step 606, the service designer can be employed in a toolset (e.g., IBM® Developer for z/OS® (IDz)) for developing and maintaining applications for refactoring and modernization.

At step 608, the source code can be tested and committed back to the toolset. The various embodiments of the present disclosure can be employed at step 608 to repair the updated source code and test cases.

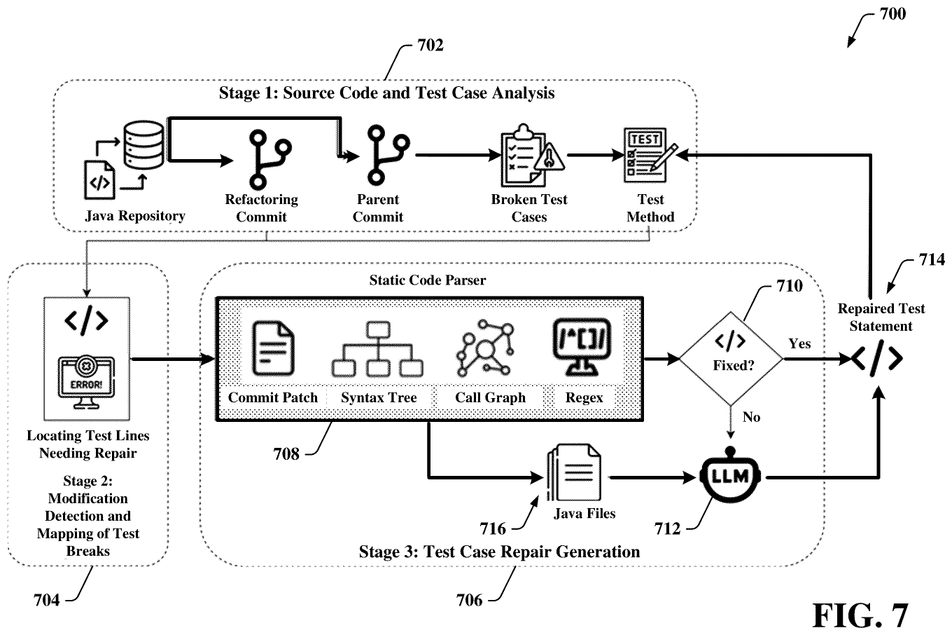

FIGS. 7-10 illustrate methods that can be employed to repair compilation errors, assertion errors and logical errors in test cases.

FIG. 7 illustrates a flow diagram of an example, non-limiting method 700 that can be employed to repair errors in test cases, in accordance with one or more embodiments described herein. Repetitive description of like elements and/or processes employed in respective embodiments is omitted for sake of brevity.

With continued reference to at least FIG. 5, non-limiting method 700 illustrates an exemplary system architecture that can be employed by error localization and repair algorithm 110 to repair errors in broken test cases. For example, test case 124 can be associated with an error such that testing source code 122 with test case 124 can lead to a failed test.

Block 702 of non-limiting method 700 illustrates stage 1 of the system architecture, wherein stage 1 can comprise source code and test case analysis. At this stage, test component 204 can access refactoring commit files and test files as inputs, and test component 204 can employ the inputs to identify the test files associated with the updated code. Thereafter, test component 204 can employ the test files to run tests (e.g., according to a test method) against source code 122.

In block 702, the java repository can comprise original source code 120 (e.g., a source code being refactored), and the refactory commit and the parent commit can track changes to original source code 120 in a version control system (VCS). In software development, a commit is an operation that can save changes made to a source code in the VCS. Specifically, a refactoring commit can modify the structure of the source code without introducing behavioral changes in the source code, whereas a parent commit can comprise the original version of the source code before refactoring. Recall that source code 122 can be generated by updating original source code 120. Accordingly, in block 702, the refactoring commit can represent source code 122, whereas the parent commit can represent original source code 120.

Block 704 of non-limiting method 700 illustrates stage 2 of the system architecture, wherein stage 2 can comprise modification detection and mapping of test breaks. At this stage, code identification component 210 can locate the test lines of test case 124 needing repairs. For example, the tests executed by test component 204 at stage 1 can result in compilation errors or assertion failures that can indicate to code identification component 210, the specific line numbers of test case 124 needing fixes. In one or more embodiments, the compilation and assertion failures can be displayed by code identification component 210 as an error message that can be viewed by an entity (e.g., hardware, software, machine, AI, neural network and/or used) at the user interface (UI) of a device (e.g., a desktop computer, a laptop computer, etc.).

Block 706 of non-limiting method 700 illustrates stage 3 of the system architecture, wherein stage 3 can comprise test case repair generation. At this stage, repair component 208 can employ program analysis techniques (e.g., via variable identification component 212, program analysis component 216) to repair the error in test case 124. For example, based on the error message, variable identification component 212 can identify the types of variables (e.g., pointers, integers, etc.) in the portion of code associated with the error and select, based on the types of variables, the appropriate program analysis techniques. Thereafter, program analysis component 216 can employ the program analysis techniques to map the refactoring in source code 122 that potentially caused the error. For example, at 708, program analysis component 216 can be a static code parser that can employ a commit patch of the refactoring commit, syntax trees of source code 122 (e.g., the refactored code under test), a call graph generated from source code 122, and/or regex patterns to parse common test fix patterns. A commit patch is a diff of a refactored code (e.g., source code 122) and an original code (e.g., original source code 120), syntax tress can be employed to find new parameters, a call graph can be employed to find new calls made and regex are rules that can be employed to find the refactoring in a test case. For example, if a commit diff shows a name change, program analysis component 216 can employ program analysis to detect a class name change and identify the relevant parameters employable for object creation.

At 710, repair component 208 can check whether the error has been fixed via the commit patch, the syntax tree, the call graph and/or the regex. If yes, then at 714, repair component 208 can replace the error with the repaired test statement, and non-limiting method 700 can process to stage 1 to repair any other errors in test case 124. If not, then prompt generation component 218 can employ LLM 112 to generate code fixes 130 that can be employed to repair the error. For example, at 716, prompt generation component 218 can access the relevant Java files comprising suitable outcomes from the program analysis. Additionally, prompt generation component 218 can employ the data generated during program analysis to narrow the context that can be input to LLM 112 while specifying the code statement needing repair. Based on the narrowed context, prompt generation component 218 can generate dynamic prompt 128 comprising suitable outcomes from the program analysis. At 712, prompt generation component 218 can input dynamic prompt 128 into LLM 112, and LLM 112 can generate, based on dynamic prompt 128, code fixes 130 for the error. Recall that code fixes 130 can comprise one or more code fixes to repair the error. Thereafter, repair component 208 or LLM 112 can apply code fixes 130 to the error. LLMs can also be leveraged in complex scenarios where program analysis cannot extract the relevant information.

Finally, at 714, repair component 208 can replace the error with the repaired test statement, and non-limiting method 700 can return to stage 1 to repair any other errors in test case 124.

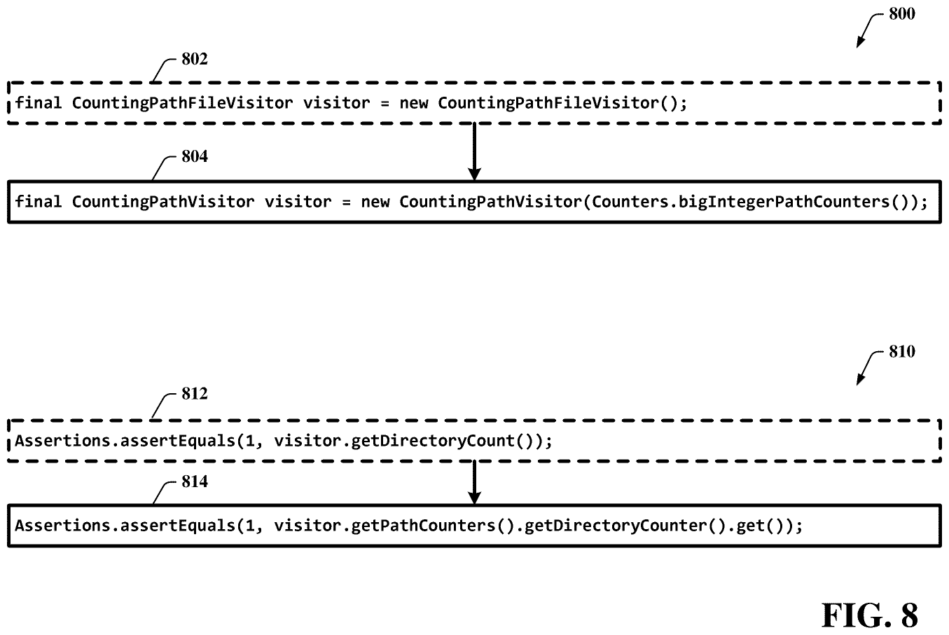

Examples of code fixes generated by error localization and repair algorithm 110 by employing non-limiting method 700 to repair compilation errors, assertion errors and logical errors in test cases are described with reference to FIGS. 8-10.

Table 5 illustrates program analysis-based code fixes generated by error localization and repair algorithm 110 for compilation errors in test cases in the context of refactoring.

TABLE 5

| Refactoring Type | Compilation Errors | Proposed Solutions |
|---|---|---|
| Class Rename | java cannot find symbol class | Commit Patch + Regex |
| | {class_name} | |
| Method Rename | java cannot find symbol method | Commit Patch + Regex |
| | {method_name} | |
| Add Parameters | java.lang.Error: Unresolved | Syntax Trees + Regex Rules |
| | compilation problem: | |
| | {method_name(parameters)} | |
| | undefined | |
| | Or | |
| | actual or formal parameters | |
| | differ in length | |
| Rename Attributes | java cannot find symbol variable | Syntax Trees + Regex Rules |
| | {variable name} | |
| Change Parameter Type | Unresolved compilation problem: | Syntax Trees + Regex Rules |
| | The {method_name(parameters)} in | |
| | the type {return_type} is not | |
| | applicable for the arguments | |
| | {(parameter 1, parameter 2)} | |
| Change Return Type | incompatible | Syntax Trees + Regex Rules |
| | types: unexpected return value | |
| Move Class | Java cannot find symbol class | Syntax Trees + Regex Rules |
| | {class_name}/variable | |
| | {class_name} | |
| Move Method | Java cannot find symbol method | Syntax Trees + Call Graph |
| | {method_name} | |

FIG. 8 illustrates example, non-limiting flow diagrams 800 and 810 of code fixes that can be employed to repair errors associated with a test case, in accordance with one or more embodiments described herein. Repetitive description of like elements and/or processes employed in respective embodiments is omitted for sake of brevity.

The various embodiments of the present disclosure were experimentally employed to generate code foxes for broken test cases according to the following experimental setup:

```
  Repository: apache/commons-io repository from GitHub ™
  Commit ID: 7c111fe - a refactor for counting longs and big integers. A cleaning
visitor was added.
  Sample Broken Test Method: testCountEmptyFolder( )
  Test case 2:
```

| | |
|---|---|
| 1. | @Test |
| 2. | public void testCountEmptyFolder( ) throws IOException { |
| 3. | final Path tempDirectory = |

Files.createTempDirectory(getClass( ).getCanonicalName( ));

| | |
|---|---|
| 4. | try { |
| 5. | final CountingPathFileVisitor visitor = new |

CountingPathFileVisitor( );

| | |
|---|---|
| 6. | Files. walkFileTree(tempDirectory, visitor); |
| 7. | Assertions.assertEquals(1, visitor.getDirectoryCount( )); |
| 8. | Assertions.assertEquals(0, visitor.getFileCount( )); |
| 9. | Assertions.assertEquals(0, visitor.getByteCount( )); |
| 10. | } finally { |
| 11. | Files.deleteIfExists(tempDirectory); |
| 12. | } |
| 13. | } |

Initial Errors (Class and Method(s) not found):

| | |
|---|---|
| a) | java cannot find symbol |
| | symbol: class CountingPathFileVisitor |
| | location: class org.apache.commons.io.file.CountingPathVisitorTest |
| b) | java cannot find symbol |
| | symbol: method getDirectoryCount( ) |
| | location: variable visitor of type |
| | org.apache.commons.io.file.CountingPathVisitorTest |

Herein, program analysis component 216 was employed to generate a code fix for the compilation error in line 5 of Test case 2. The compilation error in line 5 is the initial error in Test case 2. Here, the CountingPathFile Visitor class could not be recognized by the compiler. Program analysis component 216 can first determine whether the CountingPathFile Visitor class exists or has been renamed because class renaming is a common refactoring operation. In one or more embodiments, program analysis component 216 can be a parser or employ a parser that can examine each scenario based on the error while considering multiple inputs. For example, the parser can first examine the commit patch to identify instances of class renaming. If a class renaming is detected for the concerned class, the parser can proceed to inspect the constructor declarations to check for new arguments that can be employed. Herein, the parser can utilize the syntax tree to extract the arguments and gather relevant information on the correct arguments that can be passed during object creation to satisfy the constructor requirements.

Non-limiting flow diagram 800 illustrates a code fix generated by program analysis component 216 for the compilation error in Test case 2. Non-limiting flow diagram 800 illustrates a technique to repair the compilation error in line 5 in Test case 2 by employing program analysis. For example, the compilation error (block 802) can be fixed by applying refactoring changes (block 804) such as class renaming (Class rename) and changing the constructor signature (Change constructor signature).

Non-limiting flow diagram 810 illustrates a code fix generated by program analysis component 216 for an assertion error in Test case 2. Non-limiting flow diagram 810 illustrates a technique to repair an assertion error in Test case 2 by employing program analysis. For example, the assertion error in Test case 2 (block 812) can be fixed by applying refactoring changes (block 814) such as method renaming (Method rename), moving a method (Move method), and extracting a method (Extract method). Similar refactoring changes can be applied to repair other assertion statements.

Program analysis component 216 was also employed to generate code fixes for assertion errors in lines 7, 8 and 9 of Test case 2. Here, the compiler could not locate the calling methods. To generate code fixes for such assertion errors, program analysis component 216 can first check for method rename refactoring. For example, program analysis component 216 can search for the method name in the refactored code and consider whether the method names have been moved to other classes. If the name does not exist, program analysis component 216 can employ fuzzy matching to find similar method names for further inspection. For example, if program analysis component 216 cannot identify a method rename in the commit patch for the method named getDirectoryCount( ) program analysis component 216 can search for similar method names in the syntax tree and find the method name getDirectoryCounter( ) by employing the fuzzy matching technique. Thereafter, program analysis component 216 can attempt to trace the patch to the identified method by employing the call graph. However, due to the complexity in the code structure, a direct path to getDirectoryCounter( ) cannot be found. In such complex scenarios, an LLM (e.g., LLM 112) can be employed. For example, prompt generation component 218 can provide the relevant Java files extracted through the call graph information to the LLM, and the LLM can generate the appropriate calling methods to extract values from the concerned method. Test case 3 shows a repaired test method generated by applying the code fixes to the old test method of Test case 2.

Test case 3:

| | |
|---|---|
| 1. | @Test |
| 2. | public void testCountEmptyFolder( ) throws IOException { |
| 3. | final Path tempDirectory = |

Files.createTempDirectory(getClass( ).getCanonicalName( ));

```
  try {
    final CountingPathVisitor visitor = new
```

CountingPathVisitor(Counters.bigIntegerPathCounters( ));

| | |
|---|---|
| 6. | Files.walkFileTree(tempDirectory, visitor); |
| | Assertions.assertEquals(1, |

visitor.getPathCounters( ).getDirectoryCounter( ).get( ));

| | |
|---|---|
| 8. | Assertions.assertEquals(1, |

visitor.getPathCounters( ).getFileCounter( ).get( ));

| | |
|---|---|
| 9. | Assertions.assertEquals(1, |

visitor.getPathCounters( ).getByteCounter( ).get( ));

| | |
|---|---|
| 10. | } finally { |
| 11. | Files.deleteIfExists(tempDirectory); |
| 12. | } |
| 13. | } |

It should be appreciated that fixing compilation and assertion errors in Test case 2 can correspond to steps 404 and 416 of non-limiting method 400, respectively.

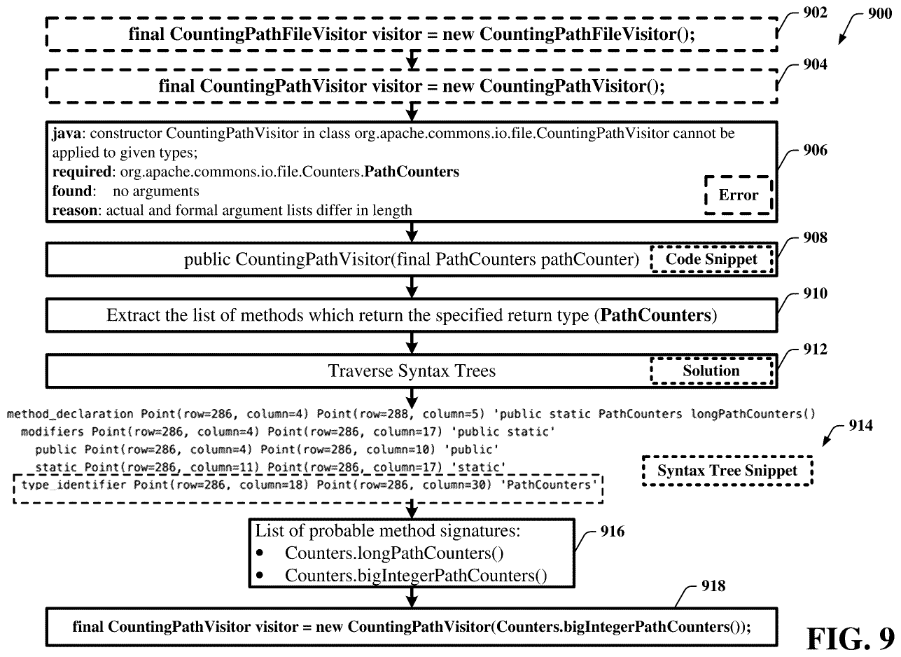

FIG. 9 illustrates a flow diagram of an example, non-limiting method 900 that can be employed to repair compilation errors in a test case by employing program analysis, in accordance with one or more embodiments described herein. Repetitive description of like elements and/or processes employed in respective embodiments is omitted for sake of brevity.

With continued reference to FIG. 8, non-limiting method 900 illustrates another method of generating a code fix for the compilation error in line 5 of Test case 2 by employing only program analysis (e.g., without employing LLMs). With reference to Table 5, the code fix generated by non-limiting method 900 corresponds to the solution of employing syntax trees and regex rules for the refactoring type ‘Add parameters.’

At step 902, program analysis component 216 can examine the code in line 6 of Test case 2.

At step 904, program analysis component 216 can examine a renamed version of the code in line 6 of Test case 2.

At step 906, program analysis component 216 can determine that the actual and formal arguments differ in length. For example, the code listed at step 902 has a different class name than the code listed at step 904. As a result, the constructor CountingPath Visitor in class org.apache.commons.io.file. CountingPath Visitor cannot be applied to the existing class, and the class org.apache.commons.io.file.Counters.PathCounters can instead be employed.

At step 908, program analysis component 216 can access the code snippet public CountingPath Visitor (final PathCounters pathCounter).

At step 910, program analysis component 216 can extract the list of methods that return the specific return type (PathCounters).

At step 912, program analysis component 216 can traverse syntax trees.

At step 914, program analysis component 216 can identify the suitable syntax tree snippet.

At step 916, program analysis component 216 can generate a list of probable method signatures based on the syntax tree snippet identified at step 914.

At step 918, program analysis component 216 can generate a new line of code that can be applied to Test case 2 to repair the compilation error in line 5.

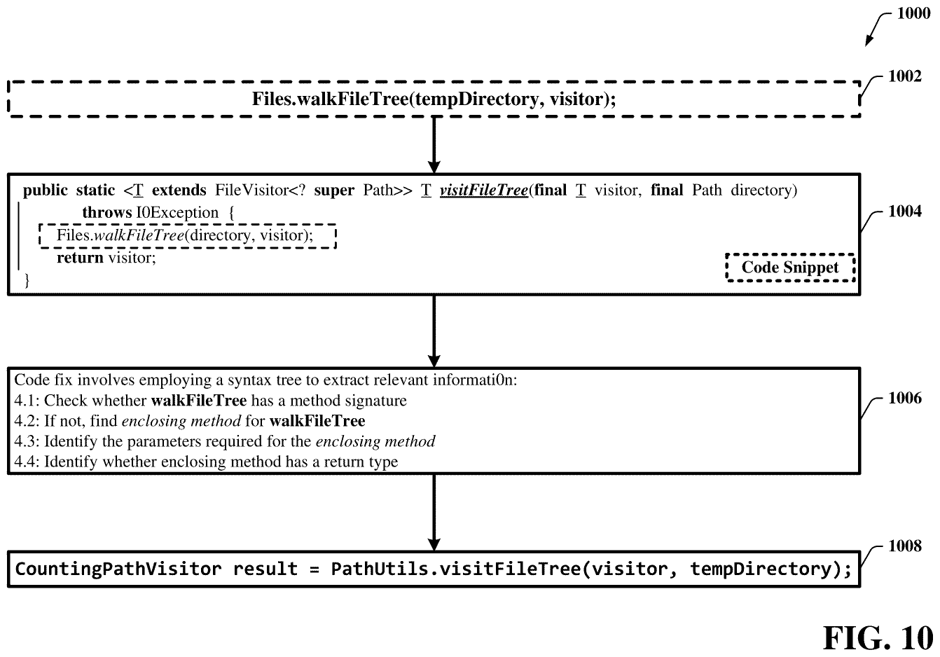

FIG. 10 illustrates a flow diagram of an example, non-limiting method 1000 that can be employed to repair compilation errors in a test case by employing program analysis and an LLM, in accordance with one or more embodiments described herein. Repetitive description of like elements and/or processes employed in respective embodiments is omitted for sake of brevity.

Line 6 of Test case 2 described with reference to FIG. 8 comprises a logical error rather than a compilation error because the statement can be invoked through a method. Non-limiting method 1000 illustrates a method of generating a code fix for a logical error in line 6 of Test case 2 by employing LLMs assisted with program analysis (diff of change, function usage). The code fix generated by non-limiting method 1000 can correspond to the refactoring type ‘Extract method.’

At step 1002, program analysis component 216 can determine that Test case 2 comprises a logical error in line 6.

At step 1004, program analysis component 216 can access the code snippet in Test case 2 comprising line 6.

At step 1006, program analysis component 216 can identify the statement in the Java files by employing syntax trees. For example, program analysis component 216 can first search for method signatures in the code snippet, followed by searching for the method in the method body to find the instance of the method name walkFileTree. If the method can be found in the method body, program analysis component 216 can extract their parameters and compare them with the parameters in walkFileTree. If the parameters are similar but the order has changed, program analysis component 216 can reorder the parameters according to the enclosing method's parameters. Thereafter, program analysis component 216 can determine the return type of the enclosing method to store the result in the relevant return type variable.

At step 1008, repair component 208 can apply the code fix generated by program analysis component 216 to line 6 of Test case 2.

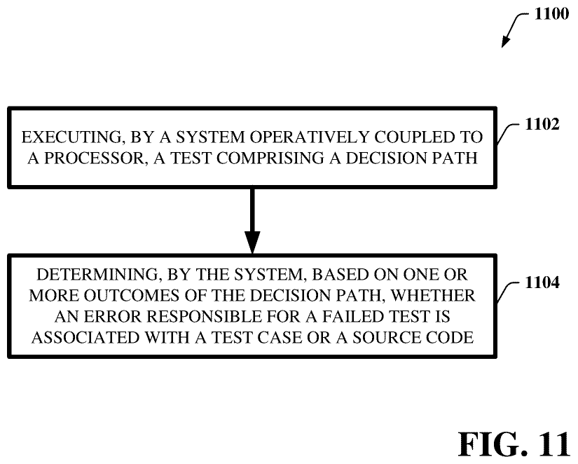

FIG. 11 illustrates a flow diagram of an example, non-limiting method 1100 that can be employed to detect errors in source codes and test cases, in accordance with one or more embodiments described herein. Repetitive description of like elements and/or processes employed in respective embodiments is omitted for sake of brevity.

At 1102, non-limiting method 1100 can comprise executing (e.g., by test component 204), by a system operatively coupled to a processor, a test comprising a decision path.

At 1104, non-limiting method 1100 can comprise determining (e.g., by localization component 206), by the system, based on one or more outcomes of the decision path, whether an error responsible for a failed test is associated with a test case or a source code.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ AI to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, Zn), to a confidence that the input belongs to a class, as by f (z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

FIG. 12 illustrates a block diagram of an example, non-limiting, operating environment 1200 in which one or more embodiments described herein can be facilitated. FIG. 12 and the following discussion are intended to provide a general description of a suitable operating environment 1200 in which one or more embodiments described herein at FIGS. 1-11 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1200 contains an example of an environment for the execution of at least some of the computer code involved in performing the inventive methods, such as error localization and repair code 1226. In addition to block 1226, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1226, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible. Computer 1201 may be located in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer-readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1226 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1226 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. IoT sensor set 1225 is made up of sensors that can be used in Internet of Things applications. For example, one sensor may be a thermometer, and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer-readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

CLOUD COMPUTING SERVICES AND/OR MICROSERVICES (not separately shown in FIG. 12): private and public clouds 1206 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer-executable components; and
a processor that executes the computer-executable components stored in the memory, wherein the computer-executable components comprise:
a test component that executes a test comprising a decision path; and
a localization component that determines, based on one or more outcomes of the decision path, whether an error responsible for a failed test is associated with a test case or a source code.

2. The system of claim 1, wherein determining whether the error is associated with the test case, or the source code comprises:
determining, by the localization component, whether the test case compiles with the source code.

3. The system of claim 1, wherein determining whether the error is associated with the test case, or the source code comprises:
determining, by the localization component, whether the test case passes a test assertion.

4. The system of claim 1, wherein determining whether the error is associated with the test case, or the source code comprises:
determining, by the localization component, an intent associated with a code update associated with the source code; and
determining, by the localization component, based on the intent, whether a behavioral change associated with the source code results from the code update or the error.

5. The system of claim 1, further comprising:
a repair component that repairs the error, wherein repairing the error comprises:
identifying, by a code identification component, via a diff-patch analysis, an updated code associated with the error; and
identifying, by the code identification component, via the diff-patch analysis, dependent components relevant to the updated code.

6. The system of claim 5, wherein the repairing the error further comprises:
identifying, by a variable identification component, one or more types of variables comprised in the updated code; and
selecting, by the variable identification component, based on the one or more types of variables, program analysis techniques relevant to the updated code.

7. The system of claim 6, wherein the repairing the error further comprises:
constructing, by a graph construction component, a dependency graph based on the program analysis techniques, wherein respective program analysis techniques are modeled as respective nodes of the dependency graph, and wherein dependencies between respective outputs of the respective program analysis techniques are modeled as edges of the dependency graph.

8. The system of claim 7, wherein the repairing the error further comprises:
performing, by a program analysis component, program analysis by employing the dependency graph, wherein the program analysis is performed on the test case, based on a determination that the error is associated with the test case or on a combination of the source code and an original source code, based on a determination that the error is associated with the source code.

9. The system of claim 8, wherein the repairing the error further comprises:
generating, by a prompt generation component, a dynamic prompt comprising data derived from the program analysis; and
inputting, by the prompt generation component, the dynamic prompt to a large language model (LLM), wherein the LLM generates, based on the dynamic prompt, one or more code fixes employable to repair the error.

10. The system of claim 9, wherein the repairing the error further comprises:
applying, by the repair component, the one or more code fixes to the error.

11. A computer-implemented method, comprising:
executing, by a system operatively coupled to a processor, a test comprising a decision path; and
determining, by the system, based on one or more outcomes of the decision path, whether an error responsible for a failed test is associated with a test case or a source code.

12. The computer-implemented method of claim 11, wherein the determining comprises:
determining, by the system, whether the test case compiles with the source code;
determining, by the system, whether the test case passes a test assertion;
determining, by the system, an intent associated with a code update associated with the source code; and
determining, by the system, based on the intent, whether a behavioral change associated with the source code results from the code update or the error.

13. The computer-implemented method of claim 11, further comprising:
repairing, by the system, the error, wherein the repairing comprises:
identifying, by the system, via a diff-patch analysis, an updated code associated with the error; and
identifying, by the system, via the diff-patch analysis, dependent components relevant to the updated code.

14. The computer-implemented method of claim 13, wherein the repairing further comprises:
identifying, by the system, one or more types of variables comprised in the updated code; and
selecting, by the system, based on the one or more types of variables, program analysis techniques relevant to the updated code.

15. The computer-implemented method of claim 14, wherein the repairing further comprises:
constructing, by the system, a dependency graph based on the program analysis techniques, wherein respective program analysis techniques are modeled as respective nodes of the dependency graph, and wherein dependencies between respective outputs of the respective program analysis techniques are modeled as edges of the dependency graph.

16. The computer-implemented method of claim 15, wherein the repairing further comprises:
performing, by the system, program analysis by employing the dependency graph, wherein the program analysis is performed on the test case, based on a determination that the error is associated with the test case or on a combination of the source code and an original source code, based on a determination that the error is associated with the source code.

17. The computer-implemented method of claim 16, wherein the repairing further comprises:
generating, by the system, a dynamic prompt comprising data derived from the program analysis; and
inputting, by the system, the dynamic prompt to an LLM, wherein the LLM generates, based on the dynamic prompt, one or more code fixes employable to repair the error.

18. The computer-implemented method of claim 17, wherein the repairing further comprises:
applying, by the system, the one or more code fixes to the error.

19. A computer program product for localizing and repairing errors in source codes and test cases, the computer program product comprising a computer readable storage medium having program instructions embodied therewith, the program instructions executable by a processor to cause the processor to:
execute, by the processor, a test comprising a decision path; and
determine, by the processor, based on one or more outcomes of the decision path, whether an error responsible for a failed test is associated with a test case or a source code.

20. The computer program product of claim 19, wherein the program instructions are further executable by the processor to cause the processor to:
determine, by the processor, an intent associated with a code update associated with the source code; and
determine, by the processor, based on the intent, whether a behavioral change associated with the source code results from the code update or the error.
